(19) United States
(12) Patent Application Publication
(10) Pub. No.: US 2015/0261276 A1
(43) Pub. Date: Sep. 17, 2015

(54) LIQUID CRYSTAL DISPLAY DEVICE

(71) Applicant: SHARP KABUSHIKI KAISHA, Osaka (JP)

(72) Inventors: Keiichi Ina, Osaka (JP); Yoshimizu Moriya, Osaka (JP); Shige Furuta, Osaka (JP)

(73) Assignee: Sharp Kabushiki Kaisha, Osaka (JP)

(21) Appl. No.: 14/434,485

(22) PCT Filed: Oct. 15, 2013
(86) PCT No.: PCT/JP2013/077960

§ 371 Date: Apr. 9, 2015

(30) Foreign Application Priority Data
Oct. 19, 2012 (JP) 2012-232232

(51) Int. Cl. G06F 1/32; G09G 3/20; G09G 3/36

(52) U.S. Cl. CPC G06F 1/3203; G09G 3/3677; G09G 3/2003

(57) ABSTRACT

The present invention provides a liquid crystal display device. During a vertical scanning period, a positive signal voltage is sent from three data signal lines corresponding to first- to third-colored pixel columns that belong to one group, and a negative signal voltage is sent from three data signal lines corresponding to first- to third-colored pixel columns that belong to another group, the two groups being adjacent to one another. Within each group, the first-colored pixel column is arranged furthest upstream, the third-colored pixel column is arranged furthest downstream, a signal voltage is sent from a data signal line positioned upstream of the first-colored pixel column to the first-colored pixel column, and a signal voltage is sent from a data signal line positioned upstream of the third-colored pixel column to the third-colored pixel column. The brightness of each pixel in the third-colored pixel column at the maximum gradation is greater than the brightness of each pixel in the first- and second-colored pixel columns at the maximum gradation.

### TECHNICAL FIELD

The present invention relates to a liquid crystal display device.

### BACKGROUND ART

Patent Document 1 discloses a problem with driving a liquid crystal display device using a dot-inversion driving method (in which the polarity of the voltage applied to each data signal line is inverted in each successive horizontal scanning period). Specifically, the problem is that vertical crosstalk occurs in each pixel column (each vertical line of pixels) due to source/drain parasitic capacitance in each pixel.

### RELATED ART DOCUMENT

### Patent Document

Patent Document 1: Japanese Patent Application Laid-Open Publication No. 2010-256917

### SUMMARY OF THE INVENTION

### Problems to be Solved by the Invention

A column-inversion driving method is effective for reducing the power consumption of a liquid crystal display device. However, when the inventors researched multi-column inversion driving methods such as the one shown in FIG. 19, in which the same signal voltage is applied to each pixel in a pixel column and the polarity of the signal voltage is inverted for each contiguous group of a certain number of pixel columns (such as three, for example), they found that the overall display quality of the liquid crystal display device is reduced due to vertical crosstalk that occurs in the green (G) pixel columns (PC2, PC5, PC8), which have the greatest brightness at a given gradation.

### Means for Solving the Problems

The present liquid crystal display device includes: a first pixel column; a plurality of pixel columns arranged in a downstream direction from the first pixel column; and a plurality of data signal lines, wherein when m is a natural number equal to no more than 3 and n is an integer equal to or greater than 3, and n pixel columns are grouped together in a contiguous manner starting from an mth pixel column and moving in the downstream direction to form ordered groups, each group includes: a first-colored pixel column that includes a plurality of pixels that transmit light of a first color, a second-colored pixel column that includes a plurality of pixels that transmit light of a second color, and a third-colored pixel column that includes a plurality of pixels that transmit light of a third color, wherein during a vertical scanning period, signal voltages of a first polarity are sent from three of the data signal lines respectively corresponding to the first- to third-colored pixel columns that belong to an upstream group, and signal voltages of a second polarity that is opposite to the first polarity are sent from three of the data signal lines respectively corresponding to the first- to third-colored pixel columns that belong to a downstream group adjacent to the upstream group, wherein within each group, the first-colored pixel column is arranged furthest upstream, the third-colored pixel column is arranged furthest downstream, a signal voltage is sent from a data signal line positioned upstream of a center of the first-colored pixel column to the first-colored pixel column, and a signal voltage is sent from a data signal line positioned upstream of a center of the third-colored pixel column to the third-colored pixel column, and wherein a brightness of each pixel in the third-colored pixel column at a maximum gradation is greater than a brightness of each pixel in the first- and second-colored pixel columns at a maximum gradation.

The present liquid crystal display device includes: a first pixel column; a plurality of pixel columns arranged in a downstream direction from the first pixel column; and a plurality of data signal lines, wherein when m is a natural number equal to no more than 2 and two pixel columns are grouped together in a contiguous manner starting from an mth pixel column and moving in the downstream direction to form ordered groups, each group includes: a multi-colored pixel column that includes a plurality of pixels that transmit light of a first color and a plurality of pixels that transmit light of a second color, and a single-colored pixel column that includes a plurality of pixels that transmit light of a third color, wherein during a vertical scanning period, signal voltages of a first polarity are sent from the two data signal lines respectively corresponding to the multi- and single-colored pixel columns that belong to an upstream group, and signal voltages of a second polarity that is opposite to the first polarity are sent from the two data signal lines respectively corresponding to the multi- and single-colored pixel columns that belong to a downstream group adjacent to the upstream group, wherein within each group, the multi-colored pixel column is arranged furthest upstream, the single-colored pixel column is arranged furthest downstream, a signal voltage is sent from a data signal line positioned upstream of a center of the multi-colored pixel column to the multi-colored pixel column, and a signal voltage is sent from a data signal line positioned upstream of a center of the single-colored pixel column to the single-colored pixel column, and wherein a brightness of each pixel in the single-colored pixel column at a maximum gradation is greater than a brightness of each pixel in the multi-colored pixel column at a maximum gradation.

### Effects of the Invention

The present invention can increase the display quality of a liquid crystal display device driven using a multi-column inversion driving method.

### BRIEF DESCRIPTION OF THE DRAWINGS

FIG. 1 schematically illustrates the polarities of signal voltages applied to each pixel column (during a first vertical scanning period) in Working Example 1.

FIG. 2 schematically illustrates the polarities of signal voltages applied to each pixel column (during a second vertical scanning period) in Working Example 1.

FIG. 3 is a block diagram illustrating a configuration of the present liquid crystal display device.

FIG. 4 schematically illustrates the pixel columns shown in FIG. 1 in more detail.

FIG. 5 is a plan view illustrating an example configuration of a single pixel of the pixel matrix shown in FIG. 1.

FIG. 6 is a plan view illustrating another example configuration of a single pixel of the pixel matrix shown in FIG. 1.

FIG. 7 schematically illustrates pixel columns in Working Example 2.

FIG. 8 schematically illustrates the polarities of signal voltages applied to each pixel column (during a first vertical scanning period) in Working Example 2.

FIG. 9 schematically illustrates the polarities of signal voltages applied to each pixel column (during a second vertical scanning period) in Working Example 2.

FIG. 10 schematically illustrates pixel columns in a modification example of Working Example 2.

FIG. 11 schematically illustrates the polarities of signal voltages applied to each pixel column (during a first vertical scanning period) in the modification example of Working Example 2.

FIG. 12 schematically illustrates the polarities of signal voltages applied to each pixel column (during a second vertical scanning period) in the modification example of Working Example 2.

FIG. 13 schematically illustrates pixel columns in Working Example 3.

FIG. 14 schematically illustrates the polarities of signal voltages applied to each pixel column (during a first vertical scanning period) in Working Example 3.

FIG. 15 schematically illustrates the polarities of signal voltages applied to each pixel column (during a second vertical scanning period) in Working Example 3.

FIG. 16 schematically illustrates pixel columns in a modification example of Working Example 3.

FIG. 17 schematically illustrates the polarities of signal voltages applied to each pixel column (during a first vertical scanning period) in the modification example of Working Example 3.

FIG. 18 schematically illustrates the polarities of signal voltages applied to each pixel column (during a second vertical scanning period) in the modification example of Working Example 3.

FIG. 19 is a schematic for explaining a problem discovered by the inventors.

### DETAILED DESCRIPTION OF EMBODIMENTS

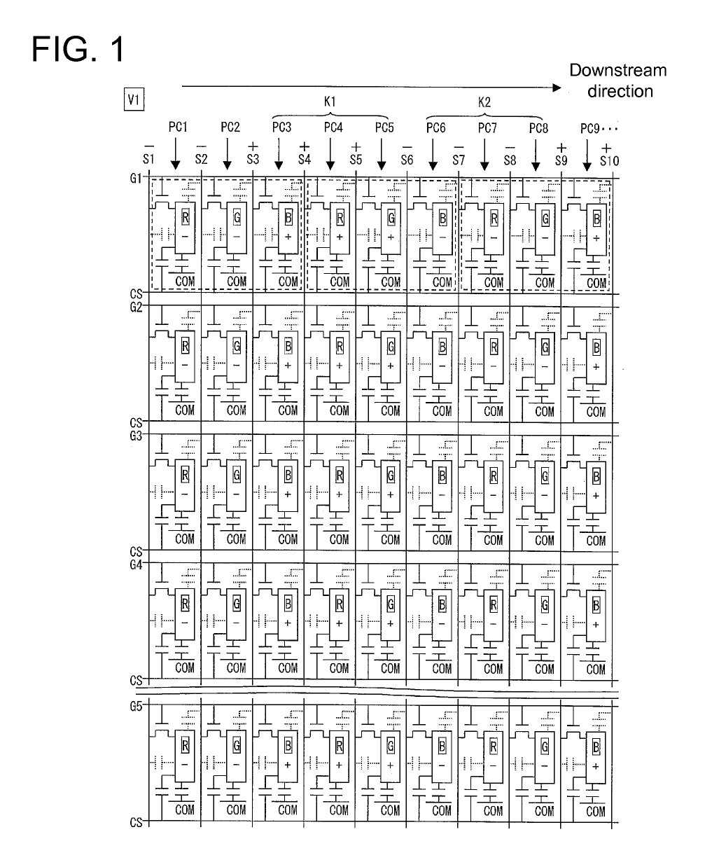

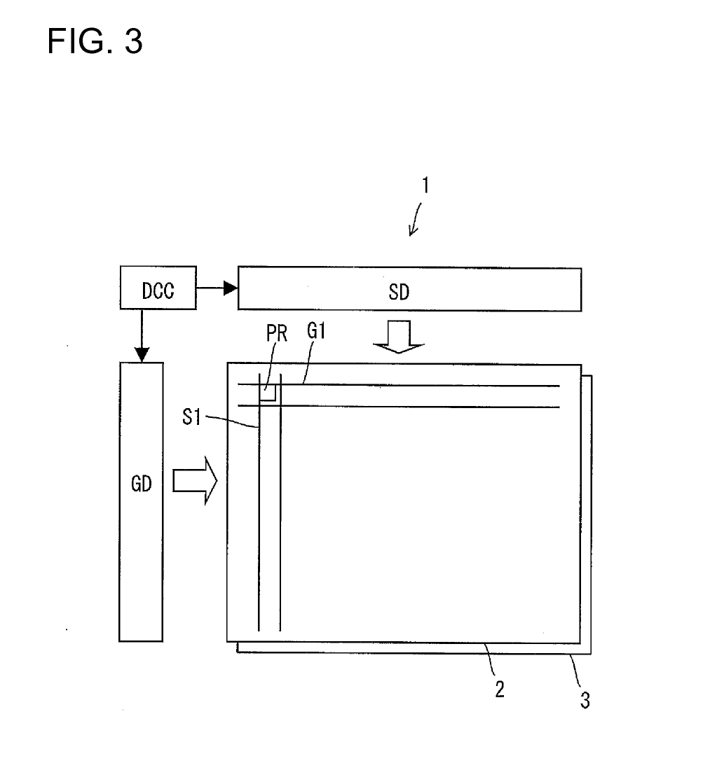

Embodiments of the present invention will be described below with reference to FIGS. 1 to 19. As shown in FIG. 3, a liquid crystal display device 1 of the present invention includes: a liquid crystal panel 2 in which a plurality of pixels (PXR . . . ) are arranged in a matrix pattern; a backlight 3 that illuminates the liquid crystal panel 2 with light; a source driver SD that drives a plurality of data signal lines (S1 . . . ) of the liquid crystal panel 2; a gate driver GD that drives a plurality of scanning signal lines (G1 . . . ) of the liquid crystal panel 2; and a display control circuit DCC that controls the source driver SD and the gate driver GD.

### Working Example 1

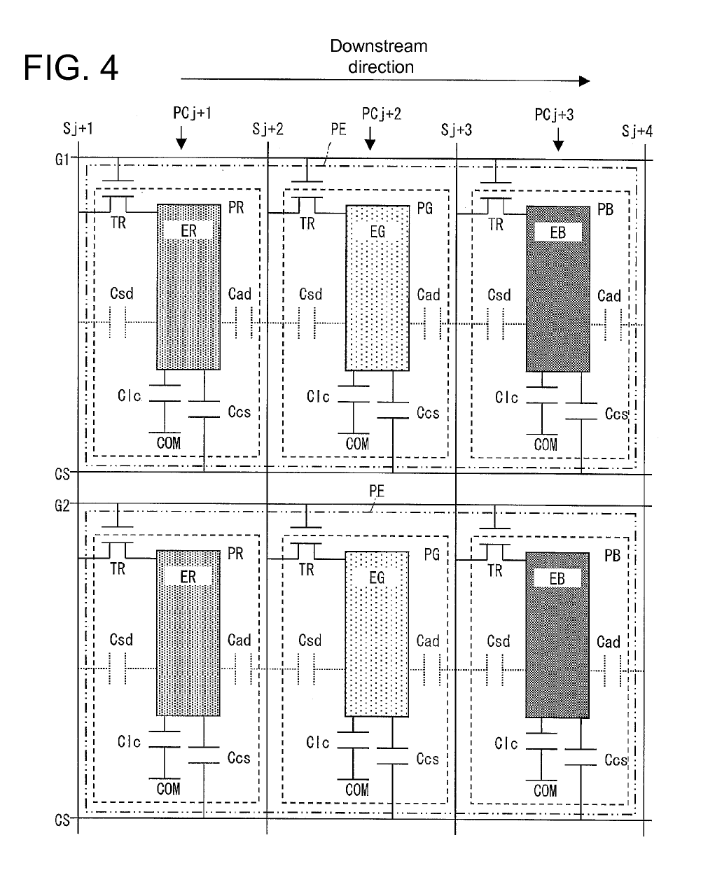

As shown in FIGS. 1 and 4, in a liquid crystal panel of Working Example 1, the direction in which the data signal lines run is the column direction, and the direction in which the scanning signal lines run is the row direction (downstream direction). j is 0 or a multiple of 3 (0, 3, 6, 9 . . . ). The (j+1)th pixel column PCⱼ₊₁ (the first pixel column, for example) is a red pixel column that includes a plurality of pixels PR that transmit red (R) light. The (j+2)th pixel column PCⱼ₊₂ (the second pixel column, for example) is a green pixel column that includes a plurality of pixels PG that transmit green (G) light. The (j+3)th pixel column PCⱼ₊₃ (the third pixel column, for example) is a blue pixel column that includes a plurality of pixels PB that transmit blue (B) light. The pixel columns PCⱼ₊₁ to PCⱼ₊₃ are arranged in order in the downstream direction.

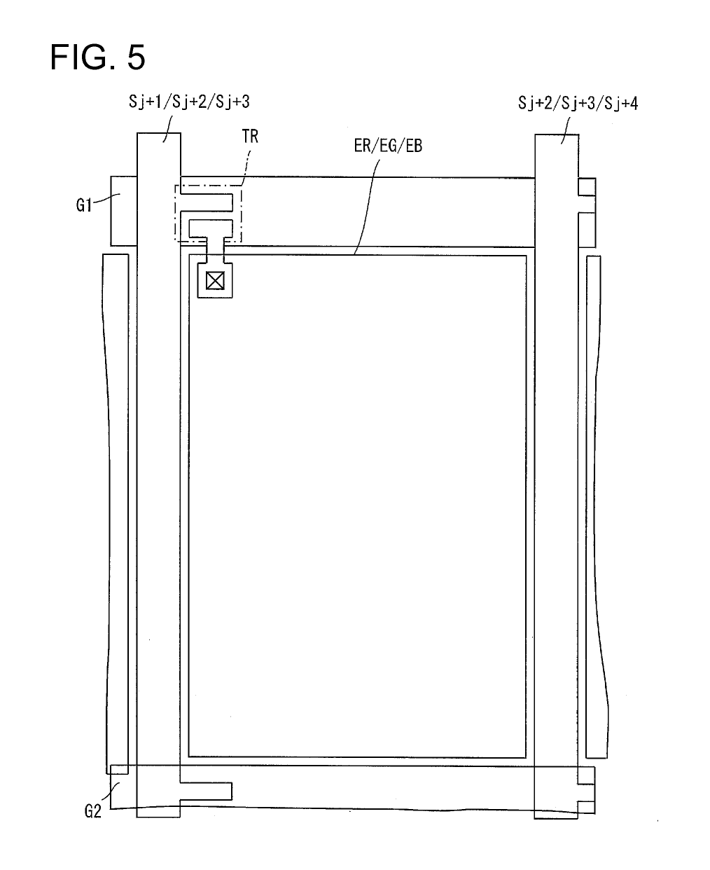

The red pixel PR in the first row includes a red color filter and a pixel electrode ER that faces a common electrode COM, and the red color filter and the pixel electrode ER are separated from one another by a liquid crystal layer. The pixel electrode ER is connected to the data signal line Sⱼ₊₁ that is disposed upstream of the center portion of the pixel column PCⱼ₊₁ via a transistor TR, and the transistor TR is connected to the scanning signal line G1. Furthermore, a liquid crystal capacitance Clc forms between the pixel electrode ER and the common electrode COM, and a storage capacitance Ccs forms between the pixel electrode ER and a storage capacitance line CS. The pixel PR is configured as shown in FIG. 5, for example, with the pixel electrode ER arranged near both the data signal line Sⱼ₊₁ and the data signal line Sⱼ₊₂. Therefore, a parasitic capacitance Csd (source/drain parasitic capacitance) forms between the pixel electrode ER and the data signal line Sⱼ₊₁, and a parasitic capacitance Cad forms between the pixel electrode ER and the data signal line Sⱼ₊₂.

Moreover, the green pixel PG in the first row includes a green color filter and a pixel electrode EG that faces the common electrode COM, and the green color filter and the pixel electrode EG are separated from one another by the liquid crystal layer. The pixel electrode EG is connected to the data signal line Sⱼ₊₂ that is disposed upstream of the center portion of the pixel column PCⱼ₊₂ via a transistor TR, and the transistor TR is connected to the scanning signal line G1. Furthermore, a liquid crystal capacitance Clc forms between the pixel electrode EG and the common electrode COM, and a storage capacitance Ccs forms between the pixel electrode EG and the storage capacitance line CS. The pixel PG is configured as shown in FIG. 5, for example, with the pixel electrode EG arranged near both the data signal line Sⱼ₊₂ and the data signal line Sⱼ₊₃. Therefore, a parasitic capacitance Csd (source/drain parasitic capacitance) forms between the pixel electrode EG and the data signal line Sⱼ₊₂, and a parasitic capacitance Cad forms between the pixel electrode EG and the data signal line Sⱼ₊₃.

Moreover, the blue pixel PB in the first row includes a blue color filter and a pixel electrode EB that faces the common electrode COM, and the blue color filter and the pixel electrode EB are separated from one another by the liquid crystal layer. The pixel electrode EB is connected to the data signal line Sⱼ₊₃ that is disposed upstream of the center portion of the pixel column PCⱼ₊₃ via a transistor TR, and the transistor TR is connected to the scanning signal line G1. Furthermore, a liquid crystal capacitance Clc forms between the pixel electrode EB and the common electrode COM, and a storage capacitance Ccs forms between the pixel electrode EB and the storage capacitance line CS. The pixel PB is configured as shown in FIG. 5, for example, with the pixel electrode EB arranged near both the data signal line Sⱼ₊₃ and the data signal line Sⱼ₊₄. Therefore, a parasitic capacitance Csd (source/drain parasitic capacitance) forms between the pixel electrode EB and the data signal line Sⱼ₊₃, and a parasitic capacitance Cad forms between the pixel electrode EB and the data signal line Sⱼ₊₄.

Moreover, the three pixels PR, PG, and PB that are arranged in order in the first row together form a picture element PE that constitutes, from a software perspective, the smallest unit of an image.

FIG. 1 schematically illustrates the polarities of signal voltages applied to each pixel column during a first vertical scanning period V1 in Working Example 1. In Working Example 1, each contiguous group of three pixels columns starting from the third pixel column PC3 and moving in the downstream direction form ordered groups (K1, K2 . . . ). Each group (K1, K2 . . . ) includes a blue (B) pixel column, a red (R) pixel column, and a green (G) pixel column. Moreover, the brightness corresponding to the maximum gradation that can be displayed by each pixel in the green pixel columns PC5 and PC8 is greater than the brightness corresponding to the maximum gradation that can be displayed by each pixel in the blue pixel columns PC3 and PC6 and the red pixel columns PC4 and PC7. (In other words, the green pixels are brighter than the red pixels and the blue pixels when displaying the same non-black gradation.)

Within the group K1, the blue pixel column PC3 is arranged furthest upstream, the green pixel column PC5 is arranged furthest downstream, and a signal voltage is sent to the blue pixel column PC3 (that is, to each pixel electrode in PC3) from the data signal line S3, which is arranged upstream of the center of the blue pixel column PC3. Moreover, a signal voltage is sent to the green pixel column PC5 (that is, to each pixel electrode in PC5) from the data signal line S5, which is arranged upstream of the center of the green pixel column PC5. Within the group K2, the blue pixel column PC6 is arranged furthest upstream, the green pixel column PC8 is arranged furthest downstream, and a signal voltage is sent to the blue pixel column PC6 (that is, to each pixel electrode in PC6) from the data signal line S6, which is arranged upstream of the center of the blue pixel column PC6. Moreover, a signal voltage is sent to the green pixel column PC8 (that is, to each pixel electrode in PC8) from the data signal line S8, which is arranged upstream of the center of the green pixel column PC8.

Furthermore, in the adjacent groups K1 and K2, K1 is disposed further upstream and K2 is disposed further downstream. During a first vertical scanning period V1, a positive signal voltage is sent from the three data signal lines S3 to S5 to the corresponding pixel columns PC3 to PC5 that belong to the group K1, and a negative signal voltage is sent from the three data signal lines S6 to S8 to the corresponding pixel columns PC6 to PC8 that belong to the group K2. Moreover, a negative signal voltage is sent from the two data signal lines S1 and S2 to the corresponding pixel columns PC1 and PC2.

In Working Example 1 as illustrated in FIG. 1, the magnitude of the crosstalk received by each pixel in the (j+1)th red pixel column (where j is 0 or a multiple of 3) from the data signal lines Sⱼ₊₁ and Sⱼ₊₂ is the absolute value of (ΔVSⱼ₊₁×Csd/(Clc+Ccs))+(ΔVSⱼ₊₂×Cad/(Clc+Ccs)). Here, ΔVSⱼ₊₁ is the difference between the electric potential of the data signal line Sⱼ₊₁ when the corresponding transistor TR is switched off and the effective electric potential of the data signal line Sⱼ₊₁ the next time the corresponding transistor TR is switched on. Moreover, ΔVSⱼ₊₂ is the difference between the electric potential of the data signal line Sⱼ₊₂ when the corresponding transistor TR is switched off and the effective electric potential of the data signal line Sⱼ₊₂ the next time the corresponding transistor TR is switched on.

Moreover, the magnitude of the crosstalk received by each pixel in the (j+2)th green pixel column (where j is 0 or a multiple of 3) from the data signal lines Sⱼ₊₂ and Sⱼ₊₃ is the absolute value of (ΔVSⱼ₊₂×Csd/(Clc+Ccs))−(ΔVSⱼ₊₃×Cad/(Clc+Ccs)). Here, ΔVSⱼ₊₂ is the difference between the electric potential of the data signal line Sⱼ₊₂ when the corresponding transistor TR is switched off and the effective electric potential of the data signal line Sⱼ₊₂ the next time the corresponding transistor TR is switched on. Moreover, ΔVSⱼ₊₃ is the difference between the electric potential of the data signal line Sⱼ₊₃ when the corresponding transistor TR is switched off and the effective electric potential of the data signal line Sⱼ₊₃ the next time the corresponding transistor TR is switched on.

Moreover, the magnitude of the crosstalk received by each pixel in the (j+3)th blue pixel column (where j is 0 or a multiple of 3) from the data signal lines Sⱼ₊₃ and Sⱼ₊₄ is the absolute value of (ΔVSⱼ₊₃×Csd/(Clc+Ccs))+(ΔVSⱼ₊₄×Cad/(Clc+Ccs)). Here, ΔVSⱼ₊₃ is the difference between the electric potential of the data signal line Sⱼ₊₃ when the corresponding transistor TR is switched off and the effective electric potential of the data signal line Sⱼ₊₃ the next time the corresponding transistor TR is switched on. Moreover, ΔVSⱼ₊₄ is the difference between the electric potential of the data signal line Sⱼ₊₄ when the corresponding transistor TR is switched off and the effective electric potential of the data signal line Sⱼ₊₄ the next time the corresponding transistor TR is switched on.

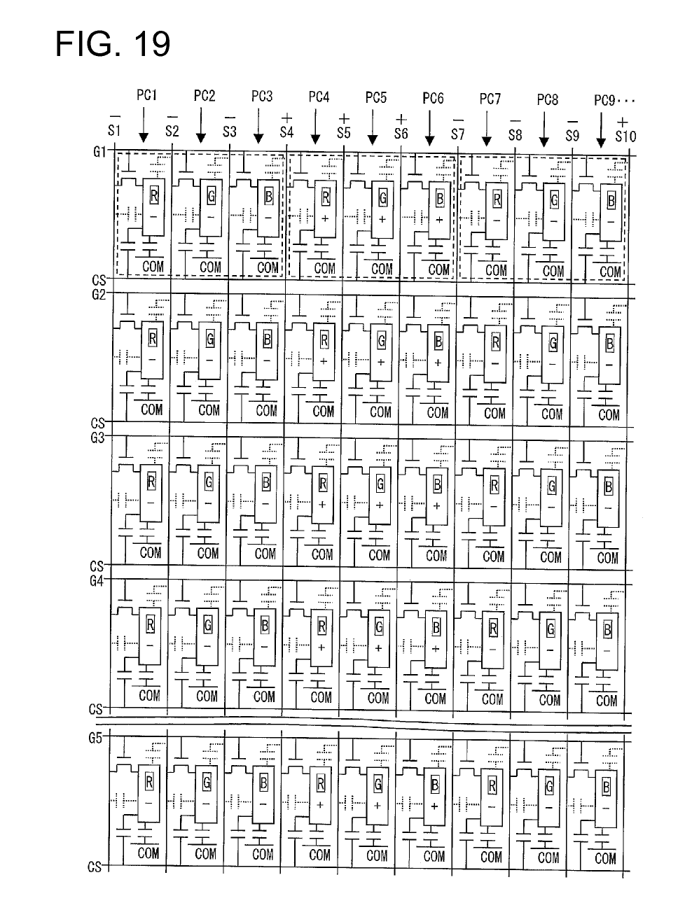

Meanwhile, in a liquid crystal display device configured as shown in FIG. 19, the magnitude of the crosstalk received by each pixel in the (j+1)th red pixel column (where j is 0 or a multiple of 3) from the data signal lines Sⱼ₊₁ and Sⱼ₊₂ is the absolute value of (ΔVS_{J+1}×Csd/(Clc+Ccs))+(ΔVSⱼ₊₂×Cad/(Clc+Ccs)). The magnitude of the crosstalk received by each pixel in the (j+2)th green pixel column (where j is 0 or a multiple of 3) from the data signal lines Sⱼ₊₂ and S_{J+3} is the absolute value of (ΔVSⱼ₊₂×Csd/(Clc+Ccs))+(ΔVSⱼ₊₃×Cad/(Clc+Ccs)). The magnitude of the crosstalk received by each pixel in the (j+3)th blue pixel column (where j is 0 or a multiple of 3) from the data signal lines Sⱼ₊₃ and Sⱼ₊₄ is the absolute value of (ΔVSⱼ₊₃×Csd/(Clc+Ccs))−(ΔVSⱼ₊₄×Cad/(Clc+Ccs)).

In this way, the overall display quality of the liquid crystal display device in Working Example 1 is increased because the magnitude of the crosstalk received by the green pixel column (which is the brightest at a given gradation) in Working Example 1 is less than in the liquid crystal display device shown in FIG. 19. One advantage of Working Example 1 is that because the pixels in each picture element can be arranged exactly as in a conventional liquid crystal display device (such as the liquid crystal display device shown in FIG. 19), the liquid crystal panel itself can be left unchanged, and only the method used to drive the liquid crystal panel needs to be changed.

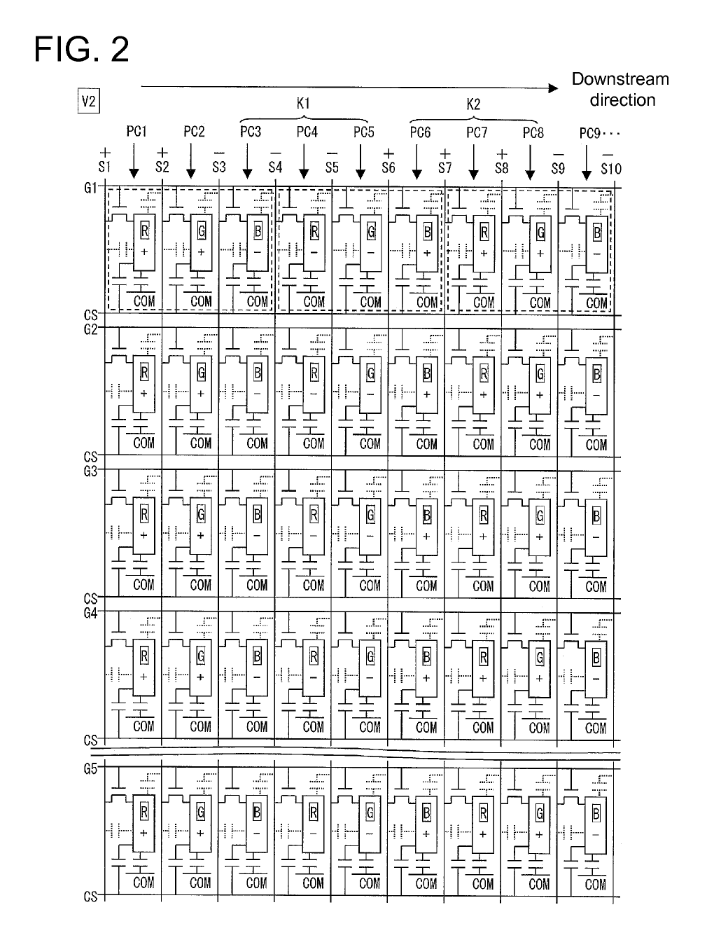

Moreover, as shown in FIG. 2, during a second vertical scanning period V2 that occurs after the first vertical scanning period V1, the polarities of the signal voltages sent to each pixel are reversed in comparison with the polarities of the signal voltages sent to each pixel during the first vertical scanning period V1.

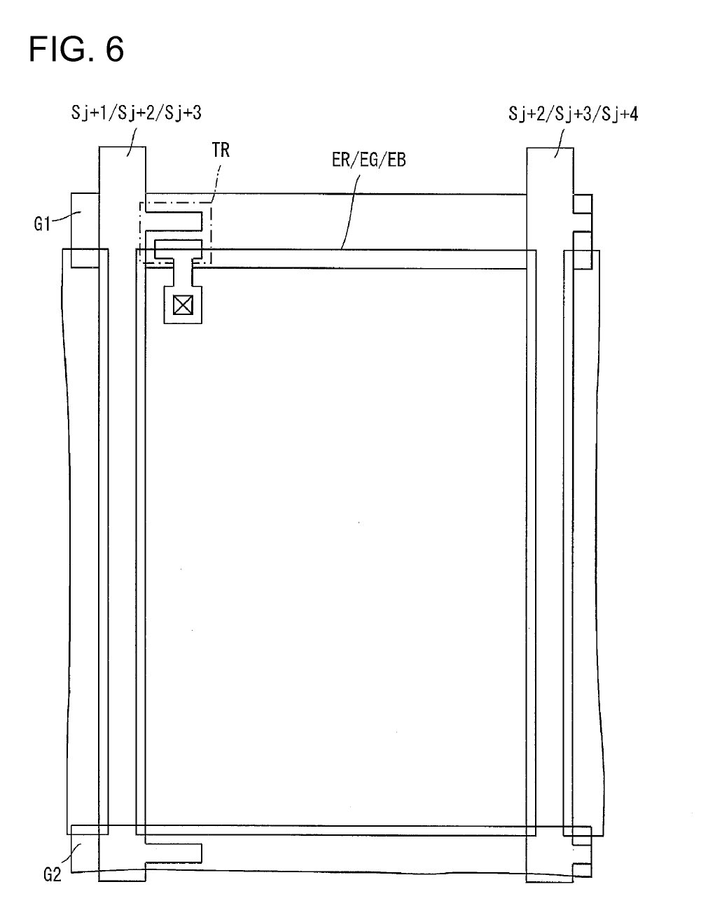

Working Example 1 is especially well-suited to a pixel configuration such as that shown in FIG. 6, where the pixel electrodes (ER/EG/EB) are sized to overlap with adjacent data signal lines (Sⱼ₊₁/Sⱼ₊₂/Sⱼ₊₃ and Sⱼ₊₂/Sⱼ₊₃/Sⱼ₊₄) (thereby causing an increase in Csd and Cad) in order to increase the aperture ratio of the device.

Working Example 1 is not limited to configurations in which each picture element includes three pixel colors (red, green, and blue), and the picture elements may be configured to include four pixel colors (red, green, blue, and yellow), for example. In this case, there would be four pixel columns in each group, and the pixel columns would be grouped such that the green or yellow pixel column (whichever exhibits the highest brightness at a given gradation) be the furthest downstream pixel column in each group.

### Working Example 2

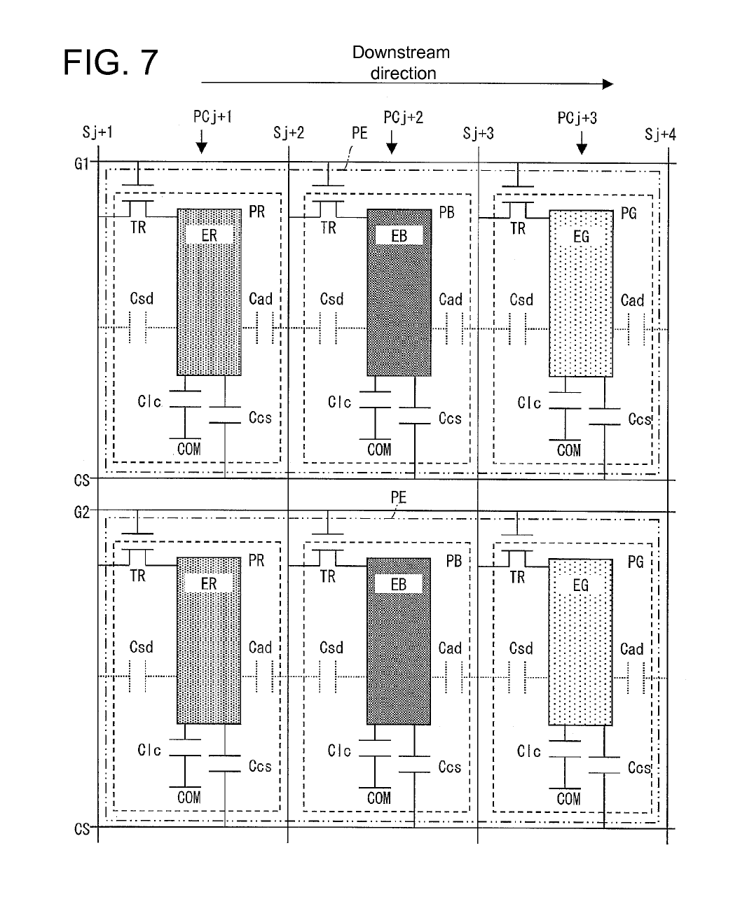

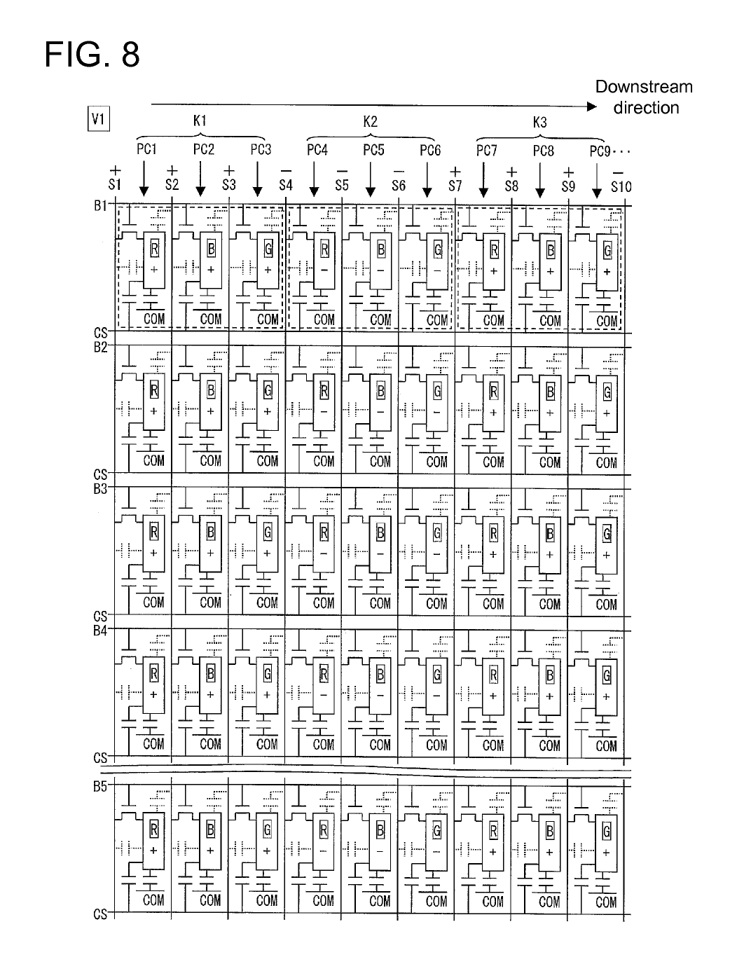

As shown in FIGS. 7 and 8, in a liquid crystal panel of Working Example 2, the (j+1)th pixel column (where j is 0 or a multiple of 3 (0, 3, 6, 9 . . . )) PCⱼ₊₁ (the first pixel column, for example) is a red pixel column that includes a plurality of pixels PR that transmit red (R) light. The (j+2)th pixel column PCⱼ₊₂ (the second pixel column, for example) is a blue pixel column that includes a plurality of pixels PB that transmit blue (B) light. The (j+3)th pixel column PCⱼ₊₃ (the third pixel column, for example) is a green pixel column that includes a plurality of pixels PG that transmit green (G) light. The pixel columns PCⱼ₊₁ to PCⱼ₊₃ are arranged in order in the downstream direction. Moreover, the three pixels PR, PB, and PG that are arranged in order in the first row together form a picture element PE that constitutes, from a software perspective, the smallest unit of an image.

FIG. 8 schematically illustrates the polarities of signal voltages applied to each pixel column during a first vertical scanning period V1 in Working Example 2. In Working Example 2, each contiguous group of three pixels columns starting from the first pixel column PC1 and moving in the downstream direction form ordered groups (K1, K2 . . . ). Each group (K1, K2 . . . ) includes a red (R) pixel column, a blue (B) pixel column, and a green (G) pixel column.

Within the group K1, the red pixel column PC1 is arranged furthest upstream, the green pixel column PC5 is arranged furthest downstream, and a signal voltage is sent to the red pixel column PC1 (that is, to each pixel electrode in PC1) from the data signal line S1, which is arranged upstream of the center of the red pixel column PC1. Moreover, a signal voltage is sent to the green pixel column PC3 (that is, to each pixel electrode in PC3) from the data signal line S3, which is arranged upstream of the center of the green pixel column PC3. Within the group K2, the red pixel column PC4 is arranged furthest upstream, the green pixel column PC6 is arranged furthest downstream, and a signal voltage is sent to the red pixel column PC4 (that is, to each pixel electrode in PC4) from the data signal line S4, which is arranged upstream of the center of the red pixel column PC4. Moreover, a signal voltage is sent to the green pixel column PC6 (that is, to each pixel electrode in PC6) from the data signal line S6, which is arranged upstream of the center of the green pixel column PC6.

Furthermore, in the adjacent groups K1 and K2, K1 is disposed further upstream and K2 is disposed further downstream. During a first vertical scanning period V1, a positive signal voltage is sent from the three data signal lines S1 to S3 to the corresponding pixel columns PC1 to PC3 that belong to the group K1, and a negative signal voltage is sent from the three data signal lines S4 to S6 to the corresponding pixel columns PC4 to PC6 that belong to the group K2.

In Working Example 2 as illustrated in FIG. 8, the magnitude of the crosstalk received by each pixel in the (j+1)th red pixel column (where j is 0 or a multiple of 3) from the data signal lines Sⱼ₊₁ and Sⱼ₊₂ is the absolute value of (ΔVSⱼ₊₁×Csd/(Clc+Ccs))+(ΔVSⱼ₊₂×Cad/(Clc+Ccs)).

Moreover, the magnitude of the crosstalk received by each pixel in the (j+2)th blue pixel column (where j is 0 or a multiple of 3) from the data signal lines Sⱼ₊₂ and Sⱼ₊₃ is the absolute value of (ΔVSⱼ₊₂×Csd/(Clc+Ccs))+(ΔVSⱼ₊₃×Cad/(Clc+Ccs)).

Moreover, the magnitude of the crosstalk received by each pixel in the (j+3)th green pixel column (where j is 0 or a multiple of 3) from the data signal lines Sⱼ₊₃ and Sⱼ₊₄ is the absolute value of (ΔVSⱼ₊₃×Csd/(Clc+Ccs))−(ΔVSⱼ₊₄×Cad/(Clc+Ccs)).

In this way, similar to Working Example 1, the overall display quality of the liquid crystal display device in Working Example 2 is increased because the magnitude of the crosstalk received by the green pixel column (which is the brightest at a given gradation) in Working Example 2 is less than in the liquid crystal display device shown in FIG. 19.

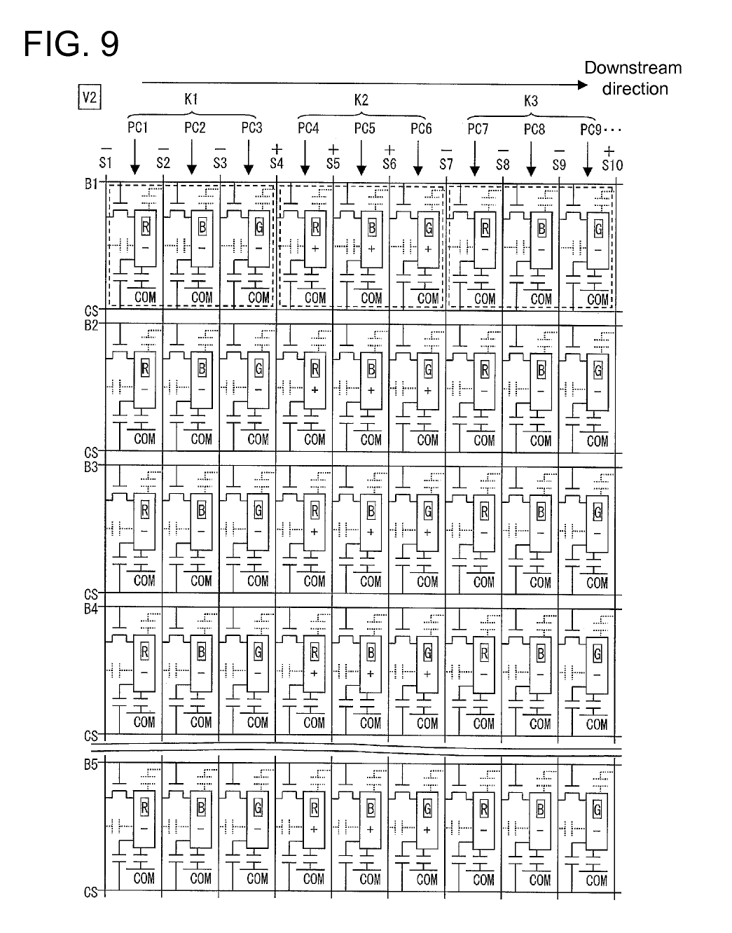

Moreover, as shown in FIG. 9, during a second vertical scanning period V2 that occurs after the first vertical scanning period V1, the polarities of the signal voltages sent to each pixel are reversed in comparison with the polarities of the signal voltages sent to each pixel during the first vertical scanning period V1.

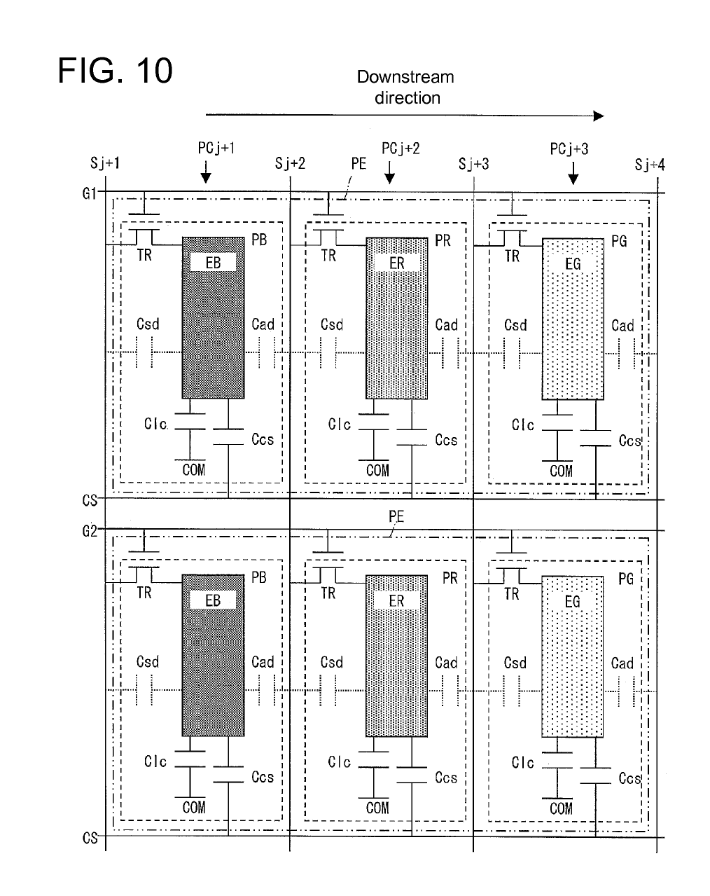

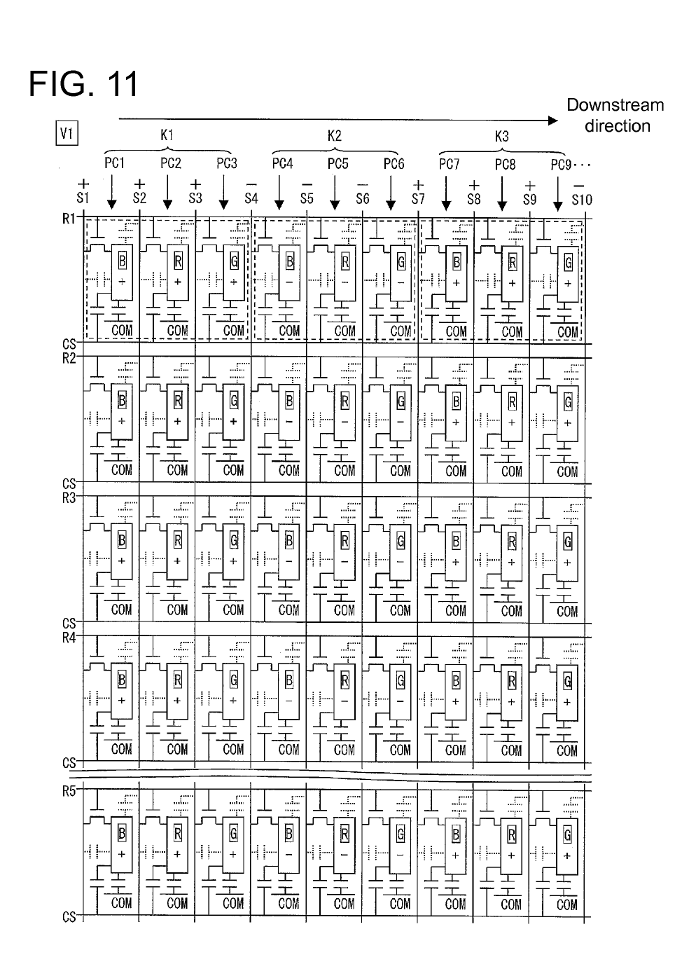

As shown in FIGS. 10 and 11, in a liquid crystal panel of a modification example of Working Example 2, the (j+1)th pixel column (where j is 0 or a multiple of 3 (0, 3, 6, 9 . . . )) PCⱼ₊₁ (the first pixel column, for example) may be a blue pixel column that includes a plurality of pixels PB that transmit blue (B) light. The (j+2)th pixel column PCⱼ₊₂ (the second pixel column, for example) may be a red pixel column that includes a plurality of pixels PR that transmit red (R) light. The (j+3)th pixel column PCⱼ₊₃ (the third pixel column, for example) may be a green pixel column that includes a plurality of pixels PG that transmit green (G) light. Here, the pixel columns PCⱼ₊₁ to PCⱼ₊₃ are still arranged in order in the downstream direction. Moreover, the three pixels PB, PR, and PG that are arranged in order in the first row together form a picture element PE that constitutes, from a software perspective, the smallest unit of an image.

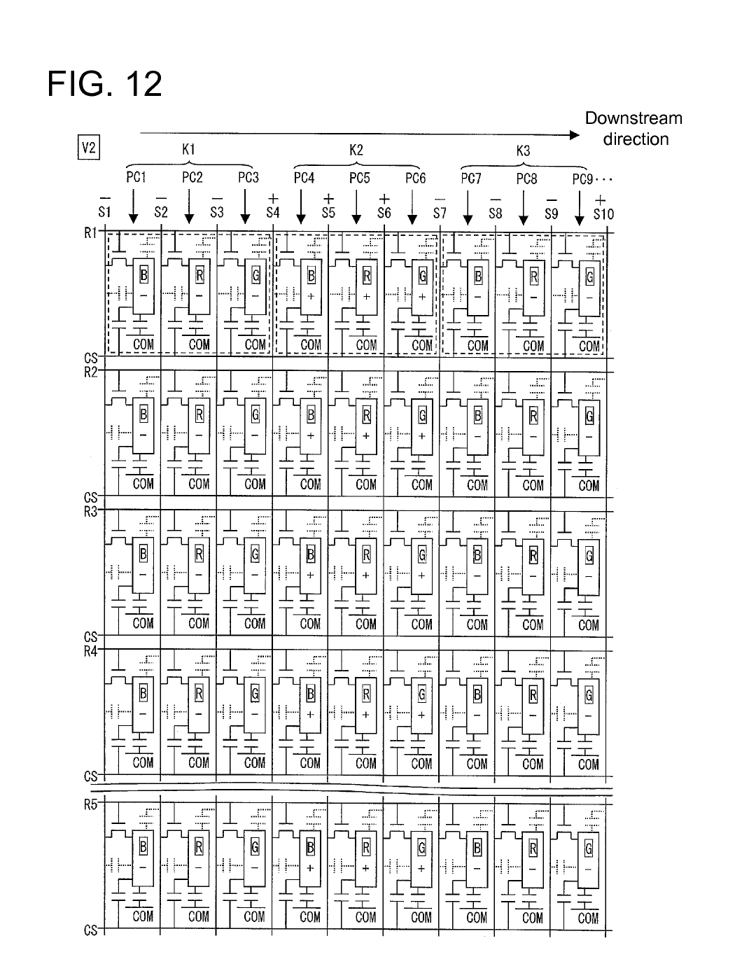

In this case, FIG. 11 illustrates the polarities of signal voltages applied to each pixel column during a first vertical scanning period V1, and FIG. 12 illustrates the polarities of signal voltages applied to each pixel column during a second vertical scanning period V2. In FIGS. 11 and 12, each contiguous group of three pixels columns starting from the first pixel column PC1 and moving in the downstream direction form ordered groups (K1, K2 . . . ). Each group (K1, K2 . . . ) includes a blue (B) pixel column, a red (R) pixel column, and a green (G) pixel column.

Furthermore, the magnitude of the crosstalk received by each pixel in the (j+1)th blue pixel column (where j is 0 or a multiple of 3) from the data signal lines Sⱼ₊₁ and Sⱼ₊₂ is the absolute value of (ΔVSⱼ₊₁×Csd/(Clc+Ccs))+(ΔVSⱼ₊₂×Cad/(Clc+Ccs)).

Moreover, the magnitude of the crosstalk received by each pixel in the (j+2)th red pixel column (where j is 0 or a multiple of 3) from the data signal lines Sⱼ₊₂ and Sⱼ₊₃ is the absolute value of (ΔVSⱼ₊₂×Csd/(Clc+Ccs))+(ΔVSⱼ₊₃×Cad/(Clc+Ccs)).

Moreover, the magnitude of the crosstalk received by each pixel in the (j+3)th green pixel column (where j is 0 or a multiple of 3) from the data signal lines Sⱼ₊₃ and Sⱼ₊₄ is the absolute value of (ΔVSⱼ₊₃×Csd/(Clc+Ccs))−(ΔVSⱼ₊₄×Cad/(Clc+Ccs)).

In this way, in the case shown in FIGS. 10 to 12, the overall display quality of the liquid crystal display device in this modification example of Working Example 2 is increased because the magnitude of the crosstalk received by the green pixel column (which is the brightest at a given gradation) in this modification example of Working Example 2 is less than in the liquid crystal display device shown in FIG. 19.

Working Example 2 is not limited to configurations in which each picture element includes three pixel colors (red, green, and blue), and the picture elements may be configured to include four pixel colors (red, green, blue, and yellow), for example. In this case, there would be four pixel columns in each group, and the pixel columns would be grouped such that the green or yellow pixel column (whichever exhibits the highest brightness at a given gradation) be the furthest downstream pixel column in each group.

### Working Example 3

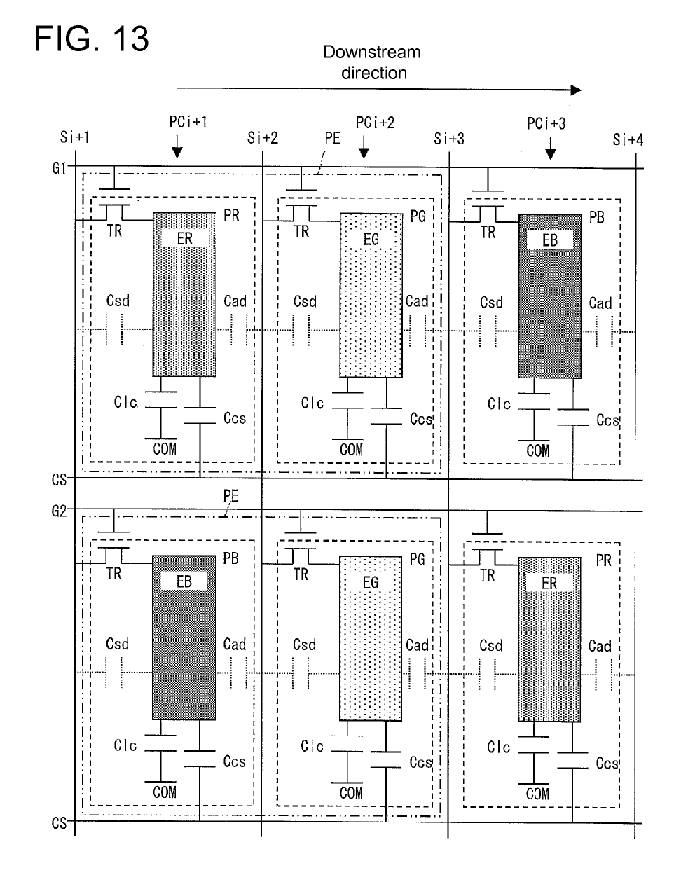

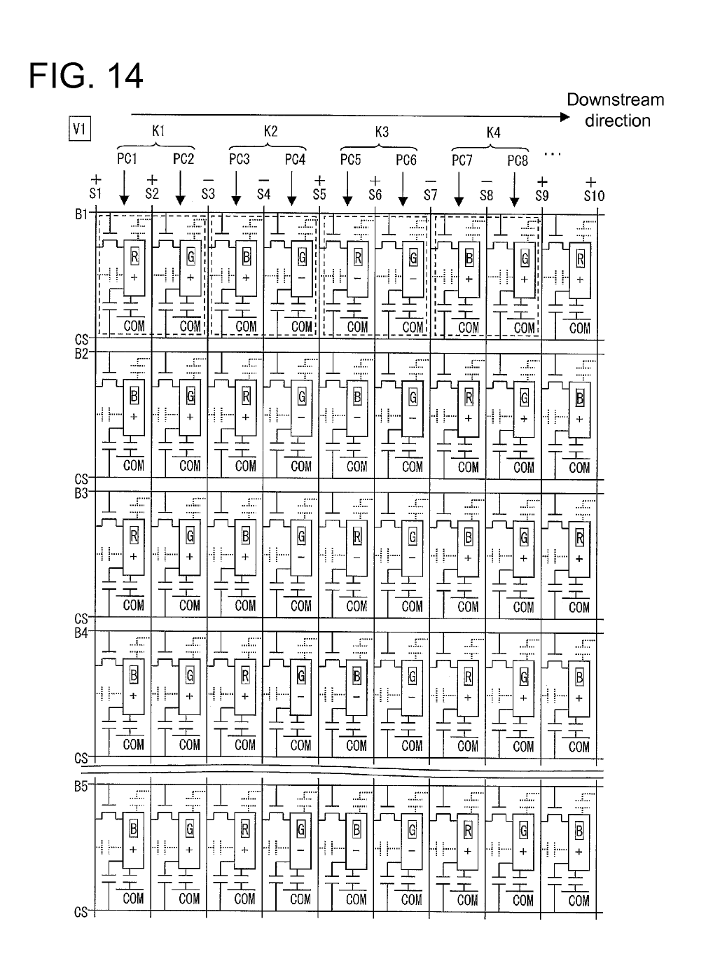

As shown in FIGS. 13 and 14, in a liquid crystal panel (a so-called PenTile liquid crystal panel) of Working Example 3, the (i+1)th pixel column (where i is 0 or an even number (0, 2, 4 . . . )) PCᵢ₊₁ (the first or third pixel column, for example) is a multi-colored pixel column that includes a plurality of pixels PR that transmit red (R) light and a plurality of pixels PB that transmit blue (B) light. The (i+2)th pixel column PCᵢ₊₂ (the second pixel column, for example) is a single-colored (green) pixel column that includes a plurality of pixels PG that transmit green (G) light. The pixel columns PCᵢ₊₁ to PCᵢ₊₃ are arranged in order in the downstream direction. Moreover, two adjacent pixels PR and PG in the first row or two adjacent pixels PB and PG in the second row, for example, together form a picture element PE that constitutes, from a software perspective, the smallest unit of an image.

FIG. 14 schematically illustrates the polarities of signal voltages applied to each pixel column during a first vertical scanning period V1 in Working Example 3. In Working Example 3, each contiguous group of two pixels columns starting from the first pixel column PC1 and moving in the downstream direction form ordered groups (K1, K2, K3, K4 . . . ). Each group (K1, K2, K3, K4 . . . ) includes a multi-colored (red/blue) pixel column and a single-colored (green) pixel column.

Within the group K1, the multi-colored (red/blue) pixel column PC1 is arranged furthest upstream, the single-colored (green) pixel column PC2 is arranged furthest downstream, and a signal voltage is sent to the multi-colored pixel column PC1 (that is, to each pixel electrode in PC1) from the data signal line S1, which is arranged upstream of the center of the multi-colored pixel column PC1. Moreover, a signal voltage is sent to the single-colored pixel column PC2 (that is, to each pixel electrode in PC2) from the data signal line S2, which is arranged upstream of the center of the single-colored pixel column PC2. Within the group K2, the multi-colored (blue/red) pixel column PC3 is arranged furthest upstream, the single-colored (green) pixel column PC4 is arranged furthest downstream, and a signal voltage is sent to the multi-colored pixel column PC3 (that is, to each pixel electrode in PC3) from the data signal line S3, which is arranged upstream of the center of the multi-colored pixel column PC3. Moreover, a signal voltage is sent to the single-colored pixel column PC4 (that is, to each pixel electrode in PC4) from the data signal line S4, which is arranged upstream of the center of the single-colored pixel column PC4.

Furthermore, in the adjacent groups K1 and K2, K1 is disposed further upstream and K2 is disposed further downstream. During a first vertical scanning period V1, a positive signal voltage is sent from the two data signal lines S1 and S2 to the corresponding pixel columns PC1 and PC2 that belong to the group K1, and a negative signal voltage is sent from the two data signal lines S3 and S4 to the corresponding pixel columns PC3 and PC4 that belong to the group K2.

In Working Example 3, the magnitude of the crosstalk received by each pixel in the (i+1)th multi-colored pixel column (where i is 0 or an even number) from the data signal lines Sᵢ₊₁ and Sᵢ₊₂ is the absolute value of (ΔVS_{i±1}×Csd/(Clc+Ccs))+(ΔVSᵢ₊₂×Cad/(Clc+Ccs)).

Moreover, the magnitude of the crosstalk received by each pixel in the (i+2)th green pixel column (where i is 0 or an even number) from the data signal lines Sᵢ₊₂ and Sᵢ₊₃ is the absolute value of (ΔVSᵢ₊₂×Csd/(Clc+Ccs))−(ΔVSᵢ₊₃×Cad/(Clc+Ccs)).

In this way, similar to Working Examples 1 and 2, the overall display quality of the liquid crystal display device in Working Example 3 is increased because the magnitude of the crosstalk received by the single-colored (green) pixel column (which is the brightest at a given gradation) in Working Example 3 is less than in the liquid crystal display device shown in FIG. 19.

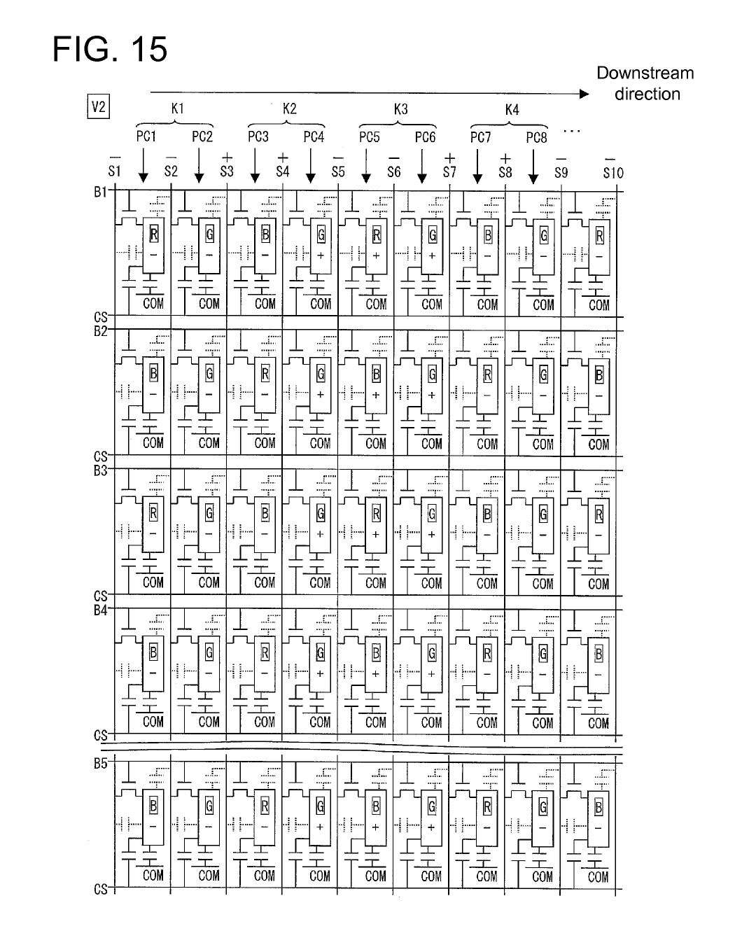

Moreover, as shown in FIG. 15, during a second vertical scanning period V2 that occurs after the first vertical scanning period V1, the polarities of the signal voltages sent to each pixel are reversed in comparison with the polarities of the signal voltages sent to each pixel during the first vertical scanning period V1.

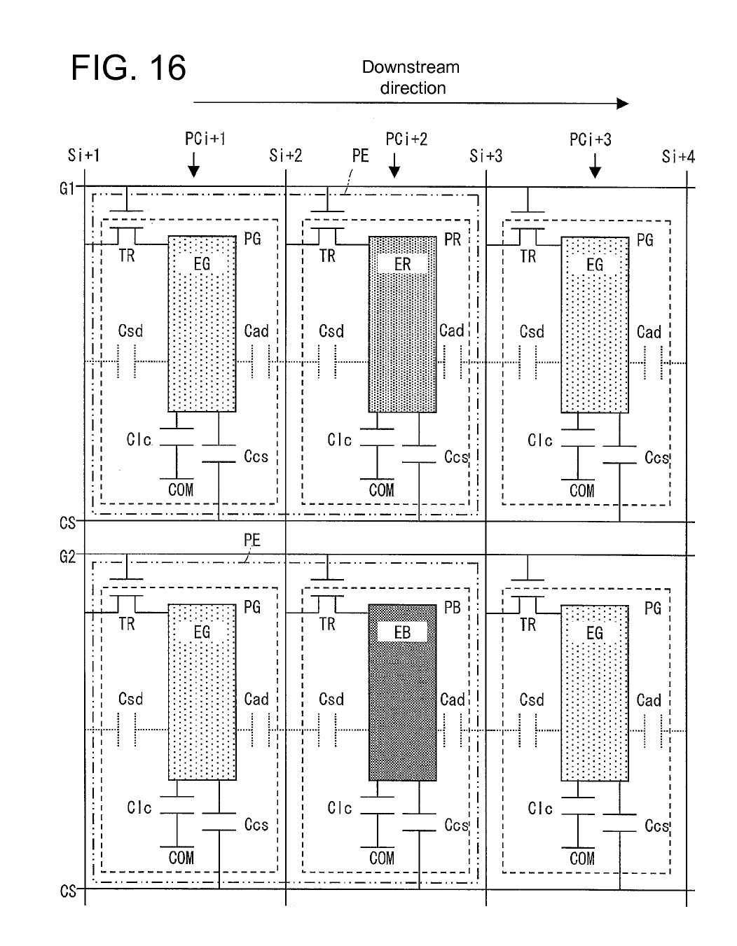

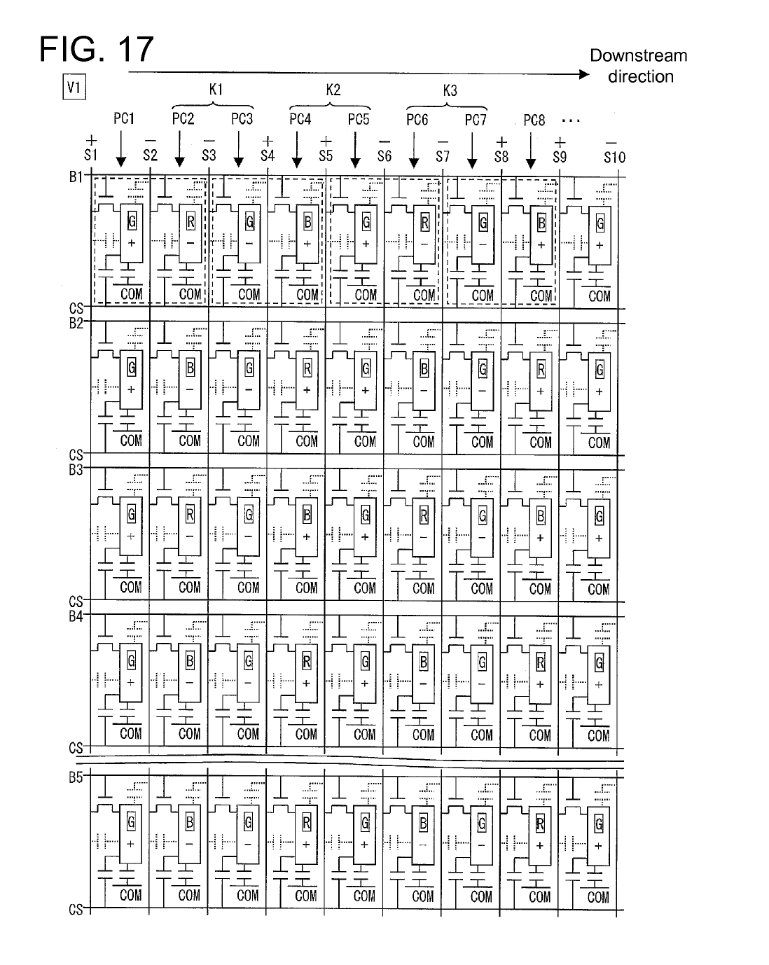

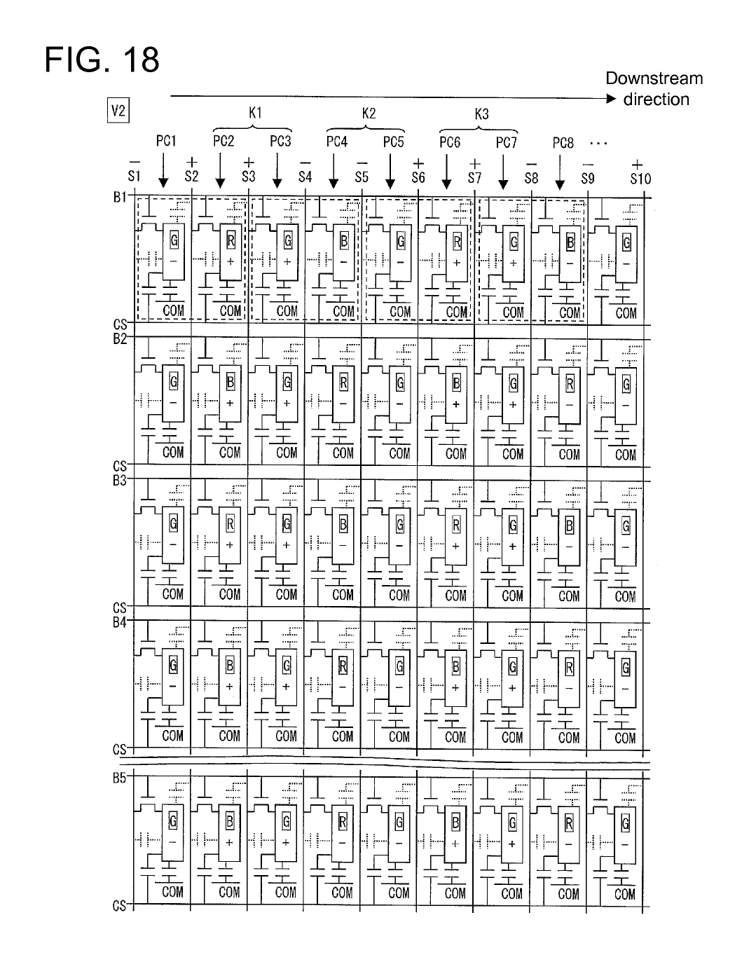

Moreover, as shown in FIG. 16, in a liquid crystal panel of a modification example of Working Example 3, the (i+1)th pixel column (where i is 0 or an even number (0, 2, 4 . . . )) PCᵢ₊₁ (the first or third pixel column, for example) may be a single-colored (green) pixel column that includes a plurality of pixels PG that transmit green (G) light. The (i+2)th pixel column PCᵢ₊₂ (the second pixel column, for example) may be a multi-colored pixel column that includes a plurality of pixels PR that transmit red (R) light and a plurality of pixels PB that transmit blue (B) light. As shown in FIGS. 17 and 18, in such a PenTile liquid crystal panel each contiguous group of two pixels columns starting from the second pixel column PC2 and moving in the downstream direction may be grouped together to form ordered groups (K1, K2, K3, K4 . . . ). One advantage of doing this is that the liquid crystal panel itself can be left unchanged, and only the method used to drive the liquid crystal panel needs to be changed.

(Summary)

As described above, the present liquid crystal display device includes: a first pixel column; a plurality of pixel columns arranged moving in a downstream direction from the first pixel column; and a plurality of data signal lines, wherein when m is a natural number equal to no more than 3 and n is an integer equal to at least 3 and contiguous groups of n pixel columns are grouped together starting from an mth pixel column and moving in the downstream direction to form ordered groups, each group includes: a first-colored pixel column that includes a plurality of pixels that transmit light of a first color, a second-colored pixel column that includes a plurality of pixels that transmit light of a second color, and a third-colored pixel column that includes a plurality of pixels that transmit light of a third color, wherein during a vertical scanning period, a signal voltage of a first polarity is sent from the three data signal lines corresponding to the first- to third-colored pixel columns that belong to an upstream group, and a signal voltage of a second polarity that is opposite to the first polarity is sent from the three data signal lines corresponding to the first- to third-colored pixel columns that belong to a downstream group, the upstream group and the downstream group being adjacent to one another, wherein within each group, the first-colored pixel column is arranged furthest upstream, the third-colored pixel column is arranged furthest downstream, a signal voltage is sent from a data signal line positioned upstream of the center of the first-colored pixel column to the first-colored pixel column, and a signal voltage is sent from a data signal line positioned upstream of the center of the third-colored pixel column to the third-colored pixel column, and wherein a brightness of each pixel in the third-colored pixel column at a maximum gradation is greater than a brightness of each pixel in the first- and second-colored pixel columns at a maximum gradation.

This configuration reduces the magnitude of the crosstalk received from nearby data signal lines by the third-colored pixel column, which has the highest brightness at a given non-black gradation. Therefore, the overall display quality of the liquid crystal display device when driven using a multi-column inversion driving method is increased.

In the present liquid crystal display device, each pixel in the third-colored pixel column that belongs to the upstream group may include a pixel electrode. Moreover, when viewed in a plan view, each pixel electrode may be arranged between the data signal line that sends a signal voltage to the third-colored pixel column that belongs to the upstream group and the data signal line that sends a signal voltage to the first-colored pixel column that belongs to the downstream group.

In the present liquid crystal display device, each pixel in the third-colored pixel column that belongs to the upstream group may include a pixel electrode. Moreover, when viewed in a plan view, each pixel electrode may overlap with at least one of the data signal line that sends a signal voltage to the third-colored pixel column that belongs to the upstream group and the data signal line that sends a signal voltage to the first-colored pixel column that belongs to the downstream group.

In the present liquid crystal display device, the third color may be green.

In the present liquid crystal display device, n may be equal to 3, one of the first color and the second color may be red, and the other one of the first color and the second color may be blue.

In the present liquid crystal display device, m may be equal to 3. Moreover, a single picture element may be formed by one pixel of the first-colored pixel column that belongs to the upstream group, one pixel of the second-colored pixel column that belongs to the upstream group, and one pixel of the third-colored pixel column that belongs to the downstream group.

In the present liquid crystal display device, m may be equal to 1. Moreover, in each group, a single picture element may be formed by one pixel of the first-colored pixel column, one pixel of the second-colored pixel column, and one pixel of the third-colored pixel column.

The present liquid crystal display device includes: a first pixel column; a plurality of pixel columns arranged moving in a downstream direction from the first pixel column; and a plurality of data signal lines, wherein when m is a natural number equal to no more than 2 and contiguous groups of two pixel columns are grouped together starting from an mth pixel column and moving in the downstream direction to form ordered groups, each group includes: a multi-colored pixel column that includes a plurality of pixels that transmit light of a first color and a plurality of pixels that transmit light of a second color, and a single-colored pixel column that includes a plurality of pixels that transmit light of a third color, wherein during a vertical scanning period, a signal voltage of a first polarity is sent from the two data signal lines corresponding to the multi- and single-colored pixel columns that belong to an upstream group, and a signal voltage of a second polarity that is opposite to the first polarity is sent from the two data signal lines corresponding to the multi- and single-colored pixel columns that belong to a downstream group, the upstream group and the downstream group being adjacent to one another, wherein within each group, the multi-colored pixel column is arranged furthest upstream, the single-colored pixel column is arranged furthest downstream, a signal voltage is sent from a data signal line positioned upstream of the center of the multi-colored pixel column to the multi-colored pixel column, and a signal voltage is sent from a data signal line positioned upstream of the center of the single-colored pixel column to the single-colored pixel column, and wherein a brightness of each pixel in the single-colored pixel column at a maximum gradation is greater than a brightness of each pixel in the multi-colored pixel column at a maximum gradation.

In the present liquid crystal display device, the third color may be green.

In the present liquid crystal display device, one of the first color and the second color may be red, and the other one of the first color and the second color may be blue.

### INDUSTRIAL APPLICABILITY

The present liquid crystal display device is suitable for use in mobile devices and other information devices, for example.

### DESCRIPTION OF REFERENCE CHARACTERS

1 liquid crystal display device
2 liquid crystal panel
3 backlight
SD source driver
GD gate driver
DCC display control circuit
K1, K2 group
PC1-PC9 pixel column
S1-S10 data signal line
PR, PG, PB pixel
ER, EG, EB pixel electrode
PE picture element

1. A liquid crystal display device, comprising:
a first pixel column;
a plurality of pixel columns arranged in a downstream direction from the first pixel column; and
a plurality of data signal lines,
wherein when m is 1, 2, or 3, and n is a positive integer equal to or greater than 3, and n pixel columns are grouped together in a contiguous manner starting from an mth pixel column and moving in the downstream direction to form ordered groups, each group includes: a first-colored pixel column that includes a plurality of pixels that transmit light of a first color, a second-colored pixel column that includes a plurality of pixels that transmit light of a second color, and a third-colored pixel column that includes a plurality of pixels that transmit light of a third color,
wherein during a vertical scanning period, signal voltages of a first polarity are sent from three of the data signal lines respectively corresponding to the first- to third-colored pixel columns that belong to an upstream group, and signal voltages of a second polarity that is opposite to the first polarity are sent from three of the data signal lines respectively corresponding to the first- to third-colored pixel columns that belong to a downstream group adjacent to the upstream group,
wherein within each group, the first-colored pixel column is arranged furthest upstream, the third-colored pixel column is arranged furthest downstream, a signal voltage is sent from a data signal line left of the first-colored pixel column to said first-colored pixel column, and a signal voltage is sent from a data signal line left of the third-colored pixel column to said third-colored pixel column, and
wherein a brightness of each pixel in the third-colored pixel column at a maximum gradation is greater than a brightness of each pixel in the first- and second-colored pixel columns at a maximum gradation.

2. The liquid crystal display device according to claim 1,
wherein each pixel in the third-colored pixel column that belongs to the upstream group includes a pixel electrode, and
wherein, in a plan view, each pixel electrode is arranged between the data signal line that sends the signal voltage to the third-colored pixel column that belongs to the upstream group and the data signal line that sends the signal voltage to the first-colored pixel column that belongs to the downstream group.

3. The liquid crystal display device according to claim 1,
wherein each pixel in the third-colored pixel column that belongs to the upstream group includes a pixel electrode, and
wherein, in a plan view, each pixel electrode overlaps with at least one of the data signal line that sends the signal voltage to the third-colored pixel column that belongs to the upstream group and the data signal line that sends the signal voltage to the first-colored pixel column that belongs to the downstream group.

4. The liquid crystal display device according to claim 1, wherein the third color is green.

5. The liquid crystal display device according to claim 3,
wherein n=3,
wherein one of the first color and the second color is red, and
wherein the other one of the first color and the second color is blue.

6. The liquid crystal display device according to claim 5,
wherein m=3, and
wherein one pixel of the first-colored pixel column that belongs to the upstream group, one pixel of the second-colored pixel column that belongs to the upstream group, and one pixel of the third-colored pixel column that belongs to the downstream group together form a single picture element.

7. The liquid crystal display device according to claim 5,
wherein m=1, and
wherein in each group, one pixel of the first-colored pixel column, one pixel of the second-colored pixel column, and one pixel of the third-colored pixel column together form a single picture element.

8. A liquid crystal display device, comprising:
a first pixel column;
a plurality of pixel columns arranged in a downstream direction from the first pixel column; and
a plurality of data signal lines,
wherein when m is 1, 2, or 3, and two pixel columns are grouped together in a contiguous manner starting from an mth pixel column and moving in the downstream direction to form ordered groups, each group includes: a multi-colored pixel column that includes a plurality of pixels that transmit light of a first color and a plurality of pixels that transmit light of a second color, and a single-colored pixel column that includes a plurality of pixels that transmit light of a third color,
wherein during a vertical scanning period, signal voltages of a first polarity are sent from the two data signal lines respectively corresponding to the multi- and single-colored pixel columns that belong to an upstream group, and signal voltages of a second polarity that is opposite to the first polarity are sent from the two data signal lines respectively corresponding to the multi- and single-colored pixel columns that belong to a downstream group adjacent to the upstream group,
wherein within each group, the multi-colored pixel column is arranged furthest upstream, the single-colored pixel column is arranged furthest downstream, a signal voltage is sent from a data signal line left of the multi-colored pixel column to said multi-colored pixel column, and a signal voltage is sent from a data signal line left of the single-colored pixel column to said single-colored pixel column, and
wherein a brightness of each pixel in the single-colored pixel column at a maximum gradation is greater than a brightness of each pixel in the multi-colored pixel column at a maximum gradation.

9. The liquid crystal display device according to claim 8, wherein the third color is green.

10. The liquid crystal display device according to claim 9,
wherein one of the first color and the second color is red, and
wherein the other one of the first color and the second color is blue.
